(19) United States
(12) Patent Application Publication
(10) Pub. No.: US 2026/0241761 A1
(43) Pub. Date: Aug. 20, 2026

(54) SUSPENSION FOR VEHICLE

(71) Applicants: HYUNDAI MOTOR COMPANY, Seoul (KR); Kia Corporation, Seoul (KR); ZF Friedrichshafen AG, Friedrichshafen (DE)

(72) Inventors: Byeongsu Yu, Hwaseong-si (KR); Byeongki Jin, Changwon-si (KR); Seunghyun Kim, Gimhae-si (KR)

(21) Appl. No.: 19/352,246

(22) Filed: Oct. 7, 2025

(30) Foreign Application Priority Data
Feb. 19, 2025 (KR) 10-2025-0021239

(51) Int. Cl. B60G 13/08; B60G 17/08

(52) U.S. Cl. CPC B60G 13/08; B60G 17/08; B60G 2202/24; B60G 2204/20; B60G 2204/40; B60G 2206/41; B60G 2206/72; B60G 2206/73; B60G 2206/8201; B60G 2500/11; B60G 2800/162; B60G 2800/916

(57) ABSTRACT

In an embodiment a suspension structure for a vehicle includes a shock absorber configured to absorb and soften vibrations of a vehicle body, a solenoid valve provided on an outer surface of the shock absorber, the solenoid valve configured to control a damping force of the shock absorber, a fixing bracket coupled to the outer surface of the shock absorber and a dust cover mount fitted and connected to the fixing bracket on an exterior circumference of the shock absorber.

### CROSS-REFERENCE TO RELATED APPLICATIONS

This application claims priority to and the benefit of Korean Patent Application No. 10-2025-0021239 filed with the Korean Intellectual Property Office on February 19, 2025, the entire contents of which are incorporated herein by reference.

### TECHNICAL FIELD

The present disclosure relates to a vehicle suspension, and more particularly, to a vehicle suspension structure including an air spring and a shock absorber.

### BACKGROUND

As a vehicle weight increases due to a transition from internal combustion engines to electric vehicles, it is common for a ride and handling (R&H) performance to deteriorate due to unfavorable inertial specifications

Accordingly, an application of more excellent suspension structures is desired, and an application of an air suspension may be desired.

The air suspension as a suspension structure with very high performance among the suspension structures known at present is a suspension that uses a rubber chamber as an air spring. A durability and a performance of the rubber chamber may vary depending on the internal volume. It may also deliver the maximum performance when being combined with an electronically controlled shock absorber.

The rubber chamber of the air spring is a component that is very vulnerable to an external impact and requires a dust cover for the protection during the operation. However, since securing the volume of the air spring and the vehicle package (an interior space, design, etc.) are typically conflict with each other, a technology that may secure a large volume of the air spring in the same space is desired.

As shown in FIG. 1, after combining an electronically controlled shock absorber 1 and an air spring 2, a dust cover 3 must be applied to protect the rubber air chamber. However, in order to secure the dust cover 3, a thin, circular steel structure 4 with a certain diameter must be welded to the shock absorber 1.

As shown in FIG. 2 and FIG. 3, a certain space is required for inserting an equipment WM for a welding operation and an equipment CM for a caulking or a curling operation to fix an external solenoid valve 5 to the electronically controlled shock absorber 1. Due to space constraints for theses caulking or curling operations, the installation position of the circular structure that holds the dust cover must be raised from 'a' to 'b'.

Since the dust cover 3 also requires a certain amount of space, moving upward the position of the circular structure that secures the dust cover 3 means reducing the volume of the air spring 2, which may cause a decrease in the durability and performance.

### SUMMARY

Accordingly, the present disclosure is intended to solve the above problems, and according to the present disclosure, a vehicle suspension structure is provided by applying a fixing bracket around a shock absorber and a dust cover mount joining structure coupled thereto to secure the durability of the air spring, and by a method of joining the dust cover mount after the welding and caulking process, thereby minimizing the space required for applying the dust cover fixing structure and then securing a large volume of the air spring.

A suspension structure for a vehicle according to an embodiment of the present disclosure includes a shock absorber coupled to an air springs, and absorbing and softening vibrations of a vehicle body; a solenoid valve provided on one side of the shock absorber to control a damping force of the shock absorber; a fixing bracket coupled to the outer surface of the shock absorber; and a dust cover mount fitted and connected to the fixing bracket on the exterior circumference of the shock absorber.

The shock absorber may be formed in a cylindrical shape.

The solenoid valve may be formed of an external valve installed on the outer surface of the shock absorber so as to extend in a direction perpendicular to the longitudinal direction of the shock absorber.

The solenoid valve may be fixed by a welding.

The end of the solenoid valve may be sealed by a caulking.

The fixing bracket may be formed in a ring shape and fixed to the outer surface of the shock absorber by a welding.

The fixing bracket may be formed of a steel.

The fixing bracket may include a fixing ring formed around the circumference of the shock absorber and mounted with a gap therebetween, and on which the dust cover mount is mounted thereon; and a fixing protrusion that is integrally formed to protrude inwardly on the inner surface of the fixing ring and is fixed to the outer surface of the shock absorber.

Only a part of the fixing protrusion may be fixed by a welding.

The fixing protrusion may be composed of a plurality of protrusions that maintain a constant interval.

The dust cover mount may be formed of a pair of symmetrical mount members that are joined to face each other and formed into a ring shape.

The dust cover mount may be formed of a plastic material.

The mount members may include a mount plate having a groove formed into which the lower part of the dust cover is inserted and fixed, and a mount hook that protrudes downward from the inner side of the mount plate and is fitted into the fixing bracket.

The mount hook may consist of a plurality of protrusions spaced at a regular interval.

The mount hook may be inserted into a space between the fixing protrusions of the fixing bracket and then fitted and coupled into the fixing protrusions by a rotation.

A fitting groove into which a part of the above fixing protrusion is fitted and coupled may be formed in the mount hook.

In the suspension for the vehicle structure according to an embodiment of the present disclosure, the fixing bracket and the above solenoid valve may be fixed to the outer surface of the shock absorber by a welding, the end of the solenoid valve may be cocked, the dust cover mount may be fitted and coupled into the fixing bracket, and the dust cover may be coupled to the dust cover mount.

According to one embodiment of the present disclosure, by applying the fixing bracket and the dust cover mount coupling structure coupled thereto around the shock absorber, the durability of the air spring is secured, and by the method of coupling the dust cover mount after the welding and caulking processes, the space required for applying the dust cover fixing structure may be minimized, thereby securing the large volume of the air spring.

### BRIEF DESCRIPTION OF THE DRAWINGS

FIG. 1 is a cross-sectional view showing a vehicle suspension structure including a conventional air spring and dust cover.

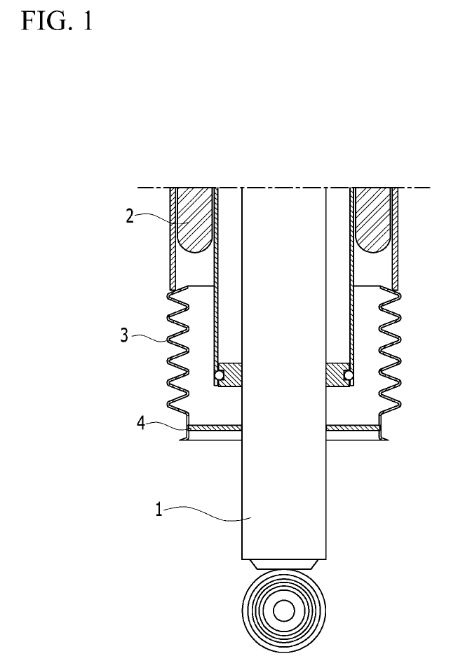

FIG. 2 is a view illustrating welding and caulking processes of a conventional vehicle suspension structure.

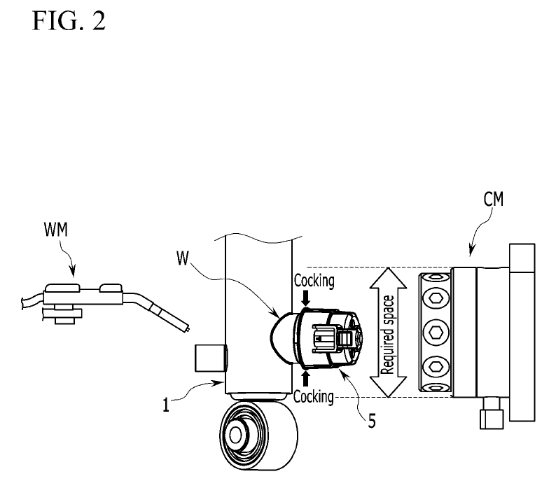

FIG. 3 is a view showing a space required for installing a conventional vehicle suspension structure.

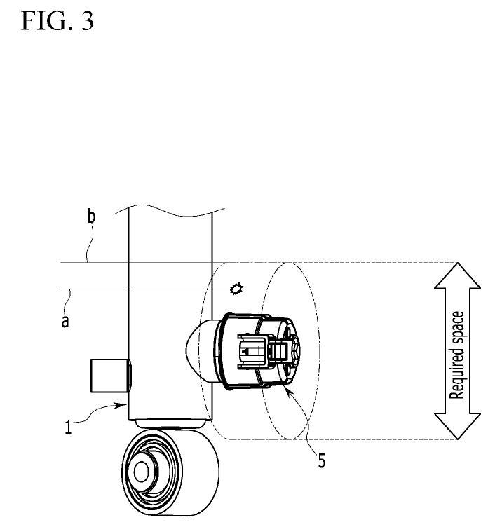

FIG. 4 is a drawing illustrating a vehicle suspension structure according to one embodiment of the present disclosure.

FIG. 5 is a view illustrating a dust cover mount of a vehicle suspension structure according to one embodiment of the present disclosure.

FIG. 6 is a view illustrating a fixing bracket of a vehicle suspension structure according to one embodiment of the present disclosure.

FIG. 7 is a view illustrating a welding process of a vehicle suspension structure according to one embodiment of the present disclosure.

FIG. 8 is a view illustrating a caulking process of a vehicle suspension structure according to one embodiment of the present disclosure.

FIG. 9 is a view showing a combined state of a fixing bracket and a dust cover mount of a vehicle suspension structure according to one embodiment of the present disclosure.

FIG. 10 is a view showing a process of combining a fixing bracket and a dust cover mount of a vehicle suspension structure according to one embodiment of the present disclosure.

### DETAILED DESCRIPTION OF ILLUSTRATIVE EMBODIMENTS

Hereinafter, some exemplary embodiments of the present invention are described in detail with reference to the accompanying drawings in order for those skilled in the art to be able to readily practice the exemplary embodiments. As those skilled in the art would realize, the described embodiments may be modified in various different ways, all without departing from the spirit or scope of the present invention.

Further, in the embodiments, like reference numerals designate like elements throughout the specification representatively in a first embodiment, and only elements of other embodiments other than those of the first embodiment will be described.

The drawings are schematic and are not proportionally scaled down. Relative scales and ratios in the drawings are enlarged or reduced for the purpose of accuracy and convenience, and the scales are random and not limited thereto. In addition, like reference numerals designate like structures, elements, or parts throughout the specification. It will be understood that when an element is referred to as being “on” another element, it can be directly on another element or intervening elements may be present therebetween.

Exemplary embodiments of the present invention views represent ideal exemplary embodiments of the present invention in detail. Therefore, various modifications of diagrams are expected. Accordingly, exemplary embodiments are not limited to specific shapes of shown regions, and for example, also include modifications of the shape by manufacturing.

Hereinafter, a vehicle suspension structure 100 according to an embodiment of the present invention will be described in detail with reference to attached drawings.

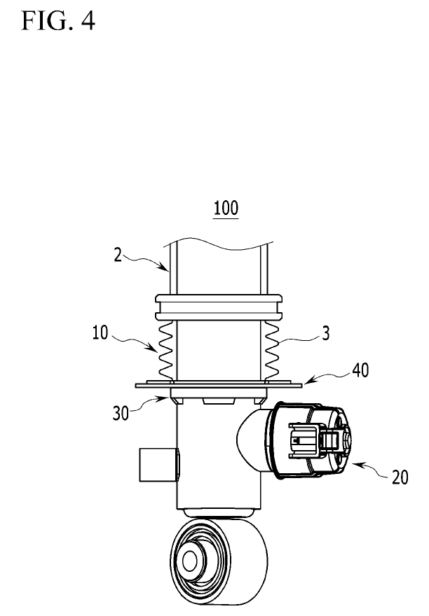

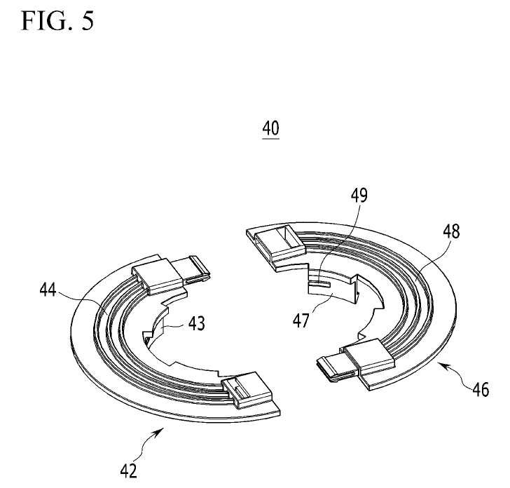

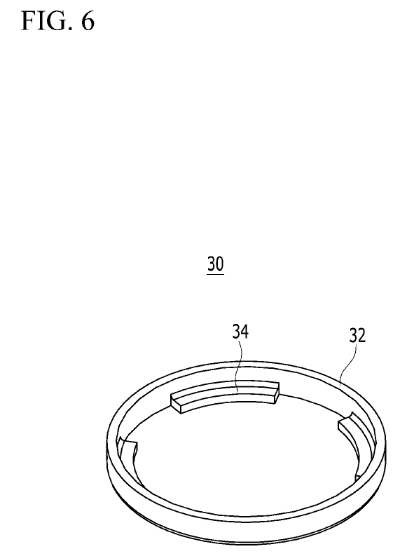

FIG. 4 is a drawing illustrating a vehicle suspension structure according to one embodiment of the present disclosure, FIG. 5 is a view illustrating a dust cover mount of a vehicle suspension structure according to one embodiment of the present disclosure, and FIG. 6 is a view illustrating a fixing bracket of a vehicle suspension structure according to one embodiment of the present disclosure.

Referring to FIG. 4, a vehicle suspension structure according to one embodiment of the present disclosure includes a shock absorber 10, a solenoid valve 20, a fixing bracket 30, and a dust cover mount 40.

The shock absorber 10 is attached to the vehicle body and functions to absorb and alleviate vibrations of the vehicle body.

The shock absorber 10 may be formed in a cylindrical shape, the upper part thereof may be connected to the body side, and the lower part may be connected to the wheel side of the vehicle. Although not shown, an air spring may be provided around the outer periphery of the shock absorber 10.

The solenoid valve 20 may be provided on one side of the outer surface of the shock absorber 10 to control the damping force of the shock absorber. The solenoid valve 20 may be formed as an external valve installed on the exterior circumference of the shock absorber 10 so as to extend in a direction perpendicular to the length direction of the shock absorber 10. The solenoid valve 20 may be an electronic control suspension (ECS) type valve that is provided to communicate with the cylinder side of the shock absorber 10 and controls a hydraulic pressure inside a cylinder by an electric signal.

The solenoid valve 20 may be fixed to the outer surface of the shock absorber 10 by a welding, and the end thereof may be sealed by a caulking. The end of the solenoid valve 20 may be covered with a cap extending in a direction perpendicular to the length of the shock absorber 10, and the cap may be caulked to prevent the hydraulic pressure inside the cylinder from leaking to the outside.

The fixing bracket 30 may be attached to the outer surface of the shock absorber 10. The fixing bracket 30 may be formed in a ring shape and be fixed to the outer surface of the shock absorber 10 by welding. The fixing bracket 30 may be fixed to the outer surface of the cylinder of the shock absorber 10 and may be made of a steel.

As shown in FIG. 6, the fixing bracket 30 may be composed of a fixing ring 32 and a fixing protrusion 34. The fixing ring 32 is formed in a ring shape with a predetermined height and thickness, and the fixing protrusion 34 may be integrally formed to protrude inwardly on the inner surface of the fixing ring 32. The fixing protrusion 34 may be composed of a plurality of protrusions that maintain a constant interval. In this embodiment, the fixing protrusion 34 may be composed of four protrusions.

The fixing protrusion 34 may be in direct contact with the outer surface of the shock absorber 10 and be fixed by a welding. Only a portion of the fixing protrusion 34 may be welded to the outer surface of the shock absorber 10. Therefore, in the state that the fixing bracket 30 is coupled to the shock absorber 10, the fixing ring 32 is mounted while forming a gap with the outer surface of the shock absorber 10, and the fixing protrusion 34 is welded and coupled in contact with the outer surface of the shock absorber 10.

A dust cover mount 40 may be placed in contact with and secured to the upper part of the fixing ring 32, and the dust cover mount 40 may be fixed via the fixing protrusion 34.

The dust cover mount 40 may be fitted and coupled into the fixing bracket 30 on the outer surface of the shock absorber 10, and a dust cover (not shown) installed to cover the outside of the air spring may be installed. The dust cover may be installed to cover a certain portion of the shock absorber 10. That is, the lower part of the dust cover is in contact with the dust cover mount 40, and the upper part of the dust cover is in contact with the circular structure, so that it is installed between the circular structure and the dust cover mount 40.

The dust cover mount 40 may be formed in a ring shape having a predetermined height and thickness, and may be composed of a pair of symmetrical mount members 42 and 46 that are coupled to face each other. The dust cover mount 40 may be made of a plastic material.

The mount members 42 and 46 may be composed of mount plates 44 and 48 having a groove formed into which the lower part of the dust cover is inserted and fixed, and mount hooks 43 and 47 that protrudes downward from the inside of the mount plate 44 and 48 and are fitted into the fixing bracket 30.

One mount member 42 may be composed of one mount plate 44 in the shape of a semicircular ring and two mount hooks 43 formed on the inner side of the mount plate 44. The groove may be provided in a semicircular ring shape on the upper surface of the mount plate 44, similar to the shape of the mount plate 44, and may be formed in multiple pieces. The ends of the mount plates 44 and 48 are fitted and coupled, so that the dust cover mount 40 has an overall ring shape. Additionally, the mount hooks 43 and 47 may be formed of a plurality of protrusions spaced at regular intervals. In this embodiment, the mount hooks 43 and 47 may be composed of four protrusions.

Meanwhile, in the present embodiment, the fixing protrusion 34 of the fixing bracket 30 may be formed of four protrusions that are arranged at constant intervals, and the mount hooks 43 and 47 may also be formed of four protrusions that are arranged at constant intervals, so that when the dust cover mount 40 is fastened to the fixing bracket 30, the mount hooks 43 and 47 may be inserted into the space between the fixing protrusions 34 and then fitted by a rotation.

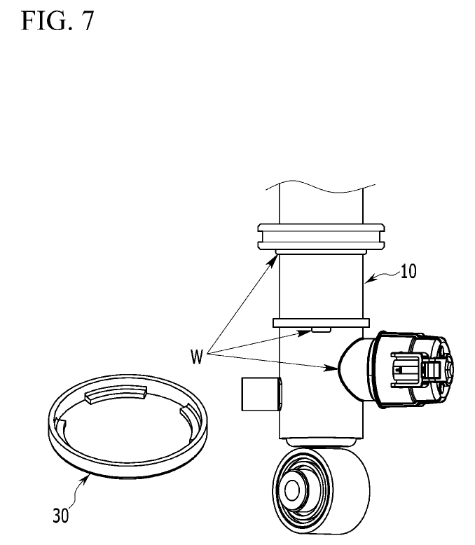

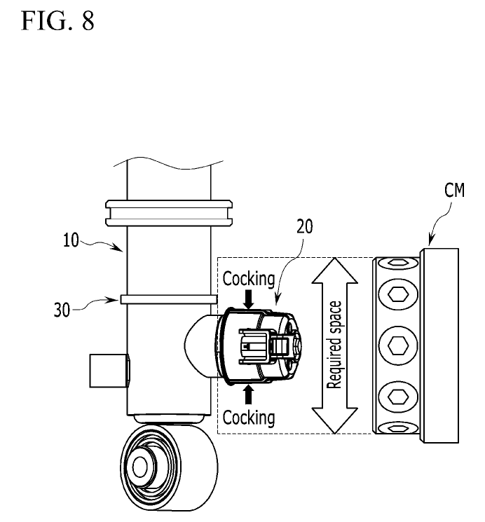

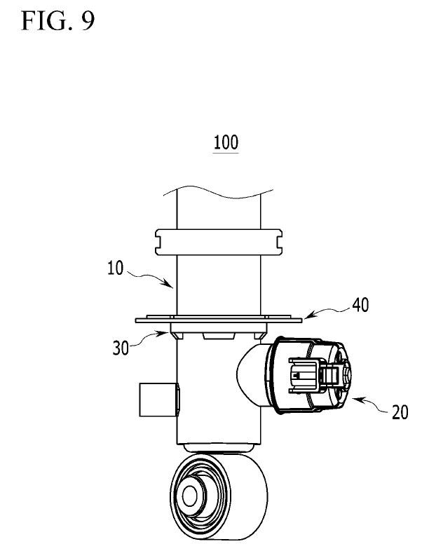

FIG. 7 is a view illustrating a welding process of a vehicle suspension structure according to one embodiment of the present disclosure, FIG. 8 is a view illustrating a caulking process of a vehicle suspension structure according to one embodiment of the present disclosure, and FIG. 9 is a view showing a combined state of a fixing bracket and a dust cover mount of a vehicle suspension structure according to one embodiment of the present disclosure.

Looking at an assembly process of a vehicle suspension structure 100 according to one embodiment of the present disclosure, as illustrated in FIG. 7, a circular structure is welded to the outer surface of the upper portion of a shock absorber 10, a fixing bracket 30 is welded to the outer surface of the central portion of the shock absorber 10, and a solenoid valve 20 is welded to the outer surface of one side of the lower portion of the shock absorber 10 so as to extend in a direction perpendicular to the longitudinal direction of the shock absorber 10.

Next, as shown in FIG. 8, the end of the solenoid valve 20 is covered by a cap, and the cap is caulked by a caulking device CM.

Since the welding and the caulking are performed in a state that a dust cover mount 40 is not installed, there are no restrictions such as an upward movement of the circular structure for the entry of a welding equipment and the caulking equipment CM or a reduction in a volume of an air spring.

Next, as shown in FIG. 9, the dust cover mount 40 is fitted and coupled into the fixing bracket 30. The dust cover mount 40 is composed of a pair of semicircular ring-shaped mount members 42 and 46 that are joined to face each other, so that the pair of mount members 42 and 46 are joined to each other on the fixing bracket 30 while the fixing bracket 30 is joined to the outer surface of the shock absorber 10. After inserting the mount hooks 43 and 47 into the space between the fixing protrusions 34 formed on the fixing bracket 30, the dust cover mount 40 is rotated to complete the fitting of the fixing bracket 30 and the dust cover mount 40.

Next, although not shown, the dust cover is installed between the circular structure and the dust cover mount 40 so as to be supported by the dust cover mount 40, thereby completing the assembly of the suspension structure (100).

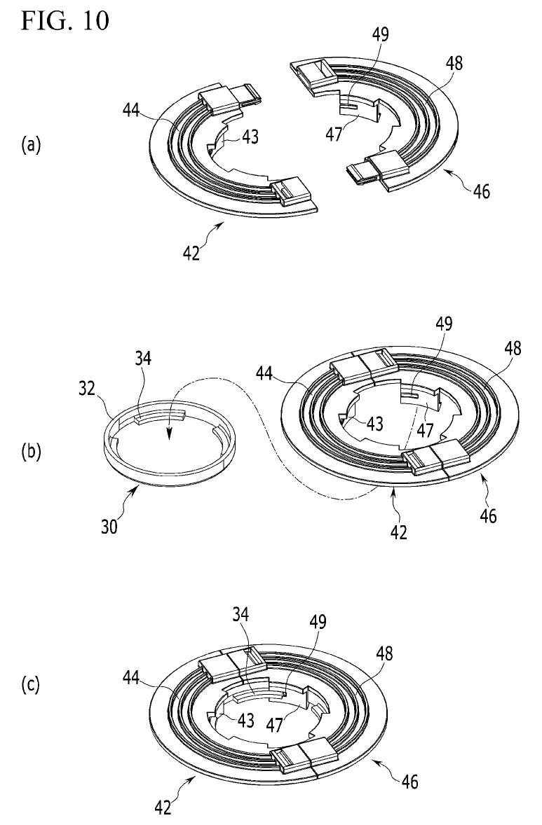

FIG. 10 is a view showing a process of combining a fixing bracket and a dust cover mount of a vehicle suspension structure according to one embodiment of the present disclosure.

As shown in FIG. 10, a dust cover mount 40 composed of a pair of semicircular ring-shaped mount members 42 and 46 that are joined to face each other is prepared (a), and the mount members 42 and 46 are joined to the upper portion of a fixing bracket 30 that is previously joined by a welding to the outer surface of a shock absorber 10. At this time, mount hooks 43 and 47 are positioned so that they are inserted into the space between the fixing protrusions 34 of the fixing bracket 30 (b). Next, the dust cover mount 40 is rotated and a part of the fixing protrusion 34 is fitted and coupled into the fitting groove 49 formed in the mount hooks 43 and 47 (c).

In this way, according to one embodiment of the present disclosure, by applying the fixing bracket and the dust cover mount coupling structure coupled thereto around the shock absorber, the durability of the air spring is secured, and by the method of coupling the dust cover mount after the welding and caulking processes, the space required for applying the dust cover fixing structure may be minimized, thereby securing the large volume of the air spring.

While this disclosure has been described in connection with what is presently considered to be practical embodiments, it is to be understood that the disclosure is not limited to the disclosed embodiments. On the contrary, it is intended to cover various modifications and equivalent arrangements included within the spirit and scope of the appended claims.

What is claimed is:

1. A suspension structure for a vehicle comprising:
a shock absorber configured to absorb and soften vibrations of a vehicle body;
a solenoid valve provided on an outer surface of the shock absorber, the solenoid valve configured to control a damping force of the shock absorber;
a fixing bracket coupled to the outer surface of the shock absorber; and
a dust cover mount fitted and connected to the fixing bracket on an exterior circumference of the shock absorber.

2. The suspension structure for the vehicle of claim 1, wherein the shock absorber has a cylindrical shape.

3. The suspension structure for the vehicle of claim 1, wherein the solenoid valve is an external valve installed on the outer surface of the shock absorber so as to extend in a direction perpendicular to a longitudinal direction of the shock absorber.

4. The suspension structure for the vehicle of claim 3, wherein the solenoid valve is welded to the outer surface of the shock absorber.

5. The suspension structure for the vehicle of claim 4, wherein an end of the solenoid valve is sealed by a caulking.

6. The suspension structure for the vehicle of claim 1, wherein the fixing bracket is ring shaped and welded to the outer surface of the shock absorber.

7. The suspension structure for the vehicle of claim 6, wherein: the fixing bracket is formed of steel.

8. The suspension structure for the vehicle of claim 1, wherein the fixing bracket includes:
a fixing ring located around the circumference of the shock absorber and mounted with a gap to the shock absorber, and
a fixing protrusion integral to the fixing ring and protruding inwardly on an inner surface of the fixing ring, wherein the fixing protrusion is fixed to the outer surface of the shock absorber.

9. The suspension structure for the vehicle of claim 8, wherein only a part of the fixing protrusion is welded to the shock absorber.

10. The suspension structure for the vehicle of claim 8, wherein the fixing protrusion comprises a plurality of protrusions, each protrusion spaced apart from a neighboring protrusion by a constant interval.

11. The suspension structure for the vehicle of claim 8, further comprising a dust cover mount comprising a pair of symmetrical mount members forming a ring, the symmetrical mount members facing each other.

12. The suspension structure for the vehicle of claim 11, wherein the dust cover mount is formed of a plastic material.

13. The suspension structure for the vehicle of claim 11, wherein each mount member includes:
a mount plate having a groove formed into which a lower part of dust cover is insertable and fixable, and
a mount hook that protrudes downward from an inner side of the mount plate and is fittable into the fixing bracket.

14. The suspension structure for the vehicle of claim 13, wherein the mount hook comprises a plurality of protrusions spaced apart at regular intervals.

15. A method of assembling a suspension structure for a vehicle, the method comprising:
welding a fixing bracket to an outer surface of a shock absorber;
welding a solenoid valve to the outer surface of the shock absorber so as to extend in a direction perpendicular to a longitudinal direction of the shock absorber;
caulking an end of the solenoid valve facing the shock absorber to seal the end;
installing a dust cover mount to the fixing bracket on an exterior circumference of the shock absorber.

16. The method of claim 15, wherein the dust cover mount is installed after welding and caulking.

17. The method of claim 15, wherein installing the dust cover mount comprises:
positioning a pair of mount members on the fixing bracket, wherein each mount member includes mount hooks; and
joining the pair of mount members together to form a ring around the exterior circumference of the shock absorber.

18. The method of claim 17, wherein installing the dust cover mount further comprises:
inserting the mount hooks into spaces between fixing protrusions of the fixing bracket; and
rotating the dust cover mount to move fitting grooves located in the mount hooks into parts of the fixing protrusions.

19. The method of claim 15, further comprising coupling a dust cover to the dust cover mount.

20. A dust cover mount comprising:
a pair of symmetrical mount members forming a ring, wherein each mount member includes:
a mount plate having a groove formed into which a dust cover is insertable and fixable, and
a mount hook that protrudes downward from an inner side of the mount plate, wherein the mount hook comprises a fitting groove.
